(19) United States
(12) Patent Application Publication
(10) Pub. No.: US 2004/0078431 A1
(43) Pub. Date: Apr. 22, 2004

(54) Method and system for chatting service providing realtime tag analysis

(76) Inventor: Jong-Sun Ahn, Seoul (KR)

Correspondence Address: CANTOR COLBURN, LLP, 55 GRIFFIN ROAD SOUTH, BLOOMFIELD, CT, 06002

(21) Appl. No.: 10/250,895

(22) PCT Filed: Jan. 16, 2002
(86) PCT No.: PCT/KR02/00067

(30) Foreign Application Priority Data
Jan. 16, 2001 (KR) 2001/2410

(51) Int. Cl. G06F 15/16

(52) U.S. Cl. 709/205

(57) ABSTRACT

This invention relates to a multimedia chatting service. Particularly, when a user copies multimedia (for example, a text, an image, a dynamic image) from a web page and pastes it to a dialogue window, the dialogue window analyzes the copied contents (multimedia) and transfers it to a chatting server. According to the present invention, the method for providing a multimedia chatting service comprises the steps of inputting the first source data and a tag format conversion request for the first source data to an operating system, wherein the first source data is stored in a buffer, receiving a second source data extracted by the operating system corresponding to the tag format conversion request, wherein the second source data comprises a tag analyzed by web browser, displaying the second source data on the user's chatting input window, transmitting the second source data as a transmission source data to the other chatting user, wherein the transmission source data is analyzed to a tag and displayed on the other user's chatting display window.

### TECHNICAL FIELD

The present invention relates to a chatting method and apparatus for providing a real-time tag analysis and transmission.

### BACKGROUND OF THE INVENTION

The present invention relates to a chatting method and apparatus for providing a real-time tag analysis and transmission.

In the past, because a user must input a tag in a chatting window with his own hands, inconvenience occurs. The tag can be analyzed like an HTML (hypertext markup language) tag by a web browser.

Also, the existing chatting method causes some inconvenience when the user copies some tags on the other web site, pastes the copied tags on the chatting window, and transmits the tags to the other chatting user.

Also, the existing chatting method has some problems by not providing a WYSIWYG (what you see is what you get) type tag editing for text, image, and moving picture.

Also, the existing chatting method cannot analyze and transmit a tag corresponding to various types of information like texts, images, moving pictures and Internet TV, and link information on real-time.

Therefore, one object of the present invention is to provide a chatting method and apparatus for analyzing copied contents into tags on real-time and transmitting analyzed tags to a server.

Another object of the present invention is to provide a chatting method and apparatus for providing a chatting window that analyzes the copied contents by the user into tags on real-time and transmits the tags.

Still another object of the present invention is to provide a chatting method and 10 apparatus for providing a WYSIWYG (what you see is what you get) type tag editing for text, image, and moving picture.

Still another object of the present invention is to provide a chatting method and apparatus for analyzing and transmitting a tag corresponding to various types of information like texts, images, moving pictures and Internet TV, and link information on real-time.

### SUMMARY OF THE INVENTION

To accomplish the objects of the present invention according to one preferred embodiment of the present invention, a method is provided for inputting the first source data and the tag format conversion request to the operating system (the first source data is stored in the buffer), receiving the second source data extracted by the operating system response to the tag format conversion request (the second source data comprises the tag which can be analyzed by web browser), displaying the second source data in a user's chatting input part and transmitting the second source data as a transmission source data to the other chatting user response to the user's transmission request (the transmission source data is received by the other chatting user and analyzed into a tag and displayed in the other chatting user's chatting display part).

The operating system has a user chatting module.

The network base chatting method for providing a real-time tag analysis further comprises the steps of storing the second source data on a user tag storage.

The user tag storage is a buffer.

To accomplish the objects of the present invention according to another preferred embodiment of the present invention, a method is provided for inputting the first source data through a chatting input part, transmitting the first source data as a transmission source data to the other chatting user response to the user's transmission request (the transmission source data is received by the other chatting user and analyzed into a tag and displayed in the other chatting user's chatting display part).

The network base chatting method further comprises the steps of receiving an edit order from a user, creating the second source data by inputting or converting the first source data response to the edit order and displaying the second source data in the chatting input part, wherein the second source data is transmitted as a transmission source data to the other chatting user response to the user's transmission request and analyzed into a tag and displayed in the other chatting user's chatting display part.

The network base chatting method further comprises the steps of displaying the first display data which is created by analyzing the first source data as a tag in the chatting display part, inputting the edit order about the first display data converting the first display data into the second display data response to the edit order displaying the second display data in the chatting display part and converting the first source data into the second source data corresponding to the second display data and displaying the second source data in the chatting input part, wherein the second source data is transmitted as a transmission source data to the other chatting user response to the user's transmission request.

The step of inputting the first source data through a chatting input part comprises the steps of receiving a paste order from the user, searching the clipboard data stored in the buffer response to the paste order and converting the clipboard data into tag-formatted data and displaying it in the chatting input part.

The step of inputting the first source data through a chatting input part is accomplished by the drag and drop order inputted by the user, wherein the source, which corresponds to more than one object_selected by the user's drag and drop order, is displayed as the first source data in the chatting input part, and the drop order is accomplished in the chatting display part or the chatting input part.

The step of inputting the first source data through a chatting input part comprises the steps of determining whether or not the first source data comprises a URL and if the first source data comprises a URL, then displaying a copyright alert message.

The network base chatting method further comprises the steps of storing the second source data in a user tag storage.

The user tag storage is a buffer.

To accomplish the objects of the present invention according to another preferred embodiment of the present invention, a method is provided for inputting the first source data and the tag format conversion request to the operating system (the first source data is stored in the buffer), receiving the second source data extracted by the operating system response to the tag format conversion request (the second source data comprises the tag which can be analyzed by web browser), displaying the second source data in a user's bulletin board input part and transmitting the second source data as transmission source data to a bulletin board service server response to the user's transmission request (the transmission source data is transmitted to the bulletin board service server and stored on the database server coupled with the bulletin board service server).

The operating system has a user bulletin board module.

The network base bulletin board method for providing a real-time tag analysis further comprises the steps of storing the second source data in a user tag storage.

The user tag storage is a buffer.

To accomplish the objects of the present invention according to another preferred embodiment of the present invention, a method is provided for inputting the first source data through a bulletin board input part, transmitting the first source data as transmission source data to a bulletin board service server response to the user's transmission request (the transmission source data is transmitted to the bulletin board service server and stored on the database server coupled with the bulletin board service server).

The network base bulletin board method further comprises the steps of receiving an edit order from a user, creating the second source data by inputting or converting the first source data response to the edit order and displaying the second source data in the bulletin board input part, wherein the second source data is transmitted as a transmission source data to the bulletin board service server response to the user's transmission request.

The network base bulletin board method further comprises the steps of displaying the first display data which is created by analyzing the first source data as a tag in the bulletin board display part, inputting the edit order about the first display data, converting the first display data into the second display data response to the edit order, displaying the second display data in the bulletin board display part and converting the first source data into the second source data corresponding to the second display data and displaying the second source data in the bulletin board input part, wherein the second source data is transmitted as a transmission source data to the bulletin board service server response to the user's transmission request.

The step of inputting the first source data through a bulletin board input part comprises the steps of receiving a paste order from the user, searching the clipboard data stored in the buffer response to the paste order and converting the clipboard data into tag-formatted data and displaying it in the bulletin board input part.

The step of inputting the first source data through a bulletin board input part is accomplished by the drag and drop order inputted by the user, wherein the source, which corresponds to more than one object selected by the user's drag and drop order, is displayed as the first source data in the bulletin board input part, and the drop order is accomplished in the bulletin board display part or the bulletin board input part.

The step of inputting the first source data through a bulletin board input part comprises the steps of determining whether or not the first source data comprises a URL and if the first source data comprises a URL, then displaying a copyright alert message.

The network base bulletin board method further comprises the steps of storing the second source data in a user tag storage.

The user tag storage is a buffer.

### BRIEF DESCRIPTIONS OF THE DRAWINGS

The above objects and other advantages of the present invention will become more apparent by detailed descriptions of the preferred embodiments thereof with reference to the attached drawings, in which:

FIG. 1 is a schematic diagram illustrating a chatting system providing a real-time tag analysis in the present invention.

FIG. 2 is a schematic diagram illustrating a chatting module comprised on a server in the present invention.

FIG. 3 is a schematic diagram illustrating a user chatting module providing a real-time tag analysis in the present invention.

FIG. 4 is a schematic diagram illustrating an operating relationship of the chatting module and the user chatting module in the present invention.

FIG. 5a is a writing page for providing a text copy on a web browser in the present invention.

FIG. 5b is a writing page for providing an image copy on a web browser in the present invention.

FIG. 5c is a writing page for providing a moving picture copy on a web browser in the present invention.

FIG. 6a is a chatting page for transmitting a copied tag (text) in the present invention.

FIG. 6b is a chatting page for displaying the copied tag (text) in the present invention.

FIG. 7a is a chatting page for transmitting a copied tag (image) in the present invention.

FIG. 7b is a chatting page for displaying the copied tag (image) in the present invention.

FIG. 8a is a chatting page for transmitting a copied tag (moving picture) in the present invention.

FIG. 8b is a chatting page for displaying the copied tag (moving picture) in the present invention.

FIG. 9 is a flowchart illustrating the process of analyzing contents into tags on real-time and transmitting the tags in the present invention.

FIG. 10 is a flowchart illustrating the real-time tag analysis process of the user chatting module in the present invention.

FIG. 11 is a schematic diagram illustrating a user database and a chatting room database in the present invention.

FIG. 12 is a schematic diagram illustrating a user table in the present invention.

FIG. 13 is a schematic diagram illustrating a chatting room table in the present invention.

FIG. 14 is a schematic diagram illustrating an HTML storing table in the present invention.

FIG. 15 is a schematic diagram illustrating a bulletin board system in the present invention.

FIG. 16a is a writing page for transmitting a copied tag (text) in the present invention.

FIG. 16b is a viewing page for displaying the copied tag (text) in the present invention.

FIG. 17a is a writing page for transmitting a copied tag (image) in the present invention.

FIG. 17b is a viewing page for displaying the copied tag (image) in the present invention.

FIG. 18a is a writing page for transmitting a copied tag (moving picture) in the present invention.

FIG. 18b is a viewing page for displaying the copied tag (moving picture) in the present invention.

FIG. 19 is a flowchart illustrating an analysis of the contents into tags on real-time and transmitting the tags on the bulletin board system in the present invention.

FIG. 20 is a schematic diagram illustrating an operating relationship of the bulletin board module and the user bulletin board module in the present invention.

FIG. 21 is a schematic diagram illustrating a bulletin board database in the present invention.

FIG. 22 is a schematic diagram illustrating a writing list table in the present invention.

### A KEY TO NUMERICAL REFERENCES TO THE MAJOR PARTS OF THE DRAWINGS

101 . . . chatting server

103 . . . integrated chatting module

105 . . . database server

107 . . . user database

109 . . . chatting room database

111 . . . network

113 . . . user PC

115 . . . tag analyzer (web browser)

117 . . . user chatting module

119 . . . user tag storage

121 . . . bulletin board service server

123 . . . integrated bulletin board module

125 . . . bulletin board database

127 . . . user bulletin board module

201 . . . connector

203 . . . transmitter

205 . . . receiver

207 . . . interface

209 . . . processor

211 . . . memory

213 . . . DBMS

301 . . . transmitter

303 . . . receiver

305 . . . tag processor

### EMBODIMENT

Hereinafter, preferred embodiments of the present invention will be described in more detail with reference to the accompanying drawings, but it is understood that the present invention should not be limited to the following embodiments.

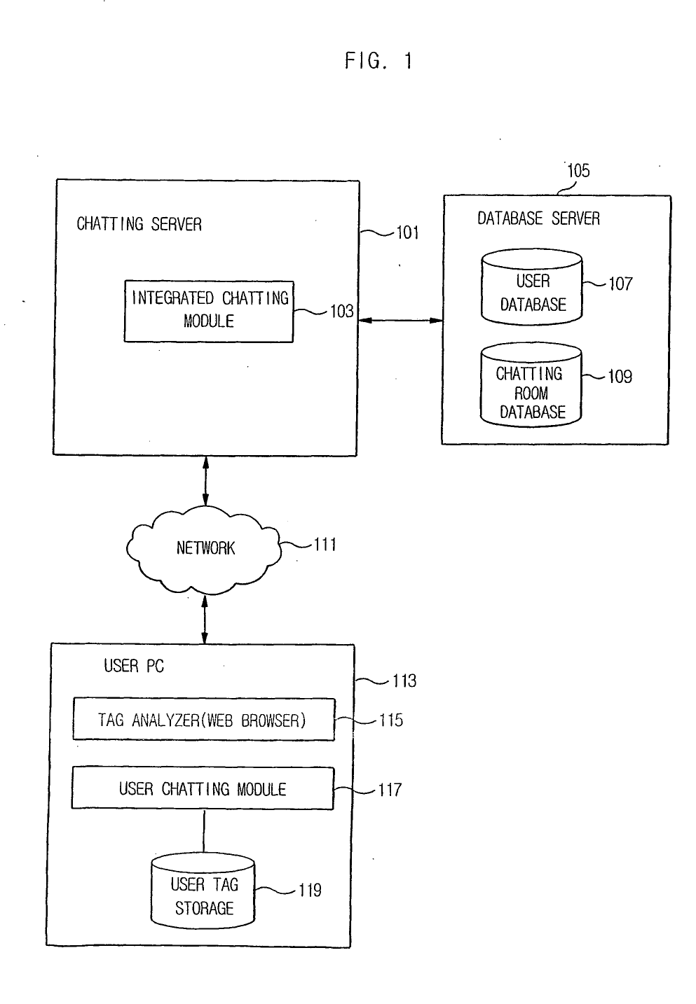

FIG. 1 is a schematic diagram illustrating a chatting system providing a real-time tag analysis in the present invention.

Referring to FIG. 1, a chatting server 101 comprises a chatting module 103 and is coupled with a database server 105. The database server 105 comprises a user database 107 and a chatting room database 109.

A user computer (user PC) 113 has a tag analyzer 115 like a web browser analyzing and displaying tags and has a user chatting module 117 transmitted from the chatting server 101. The user PC 113 comprises a user tag storage 119 (the user tag storage 119 is a buffer).

The user PC 113 is coupled with the chatting server 101 through network 111.

The chatting server 101 provides a chatting service for the users chatting through the network 111. The chatting service is to transmit a tag comprising a text, an image, and a moving picture to the chatting user's computer 113. Also, the chatting service is to display contents corresponding the transmitted tag on a chatting page by using the tag analyzer 115.

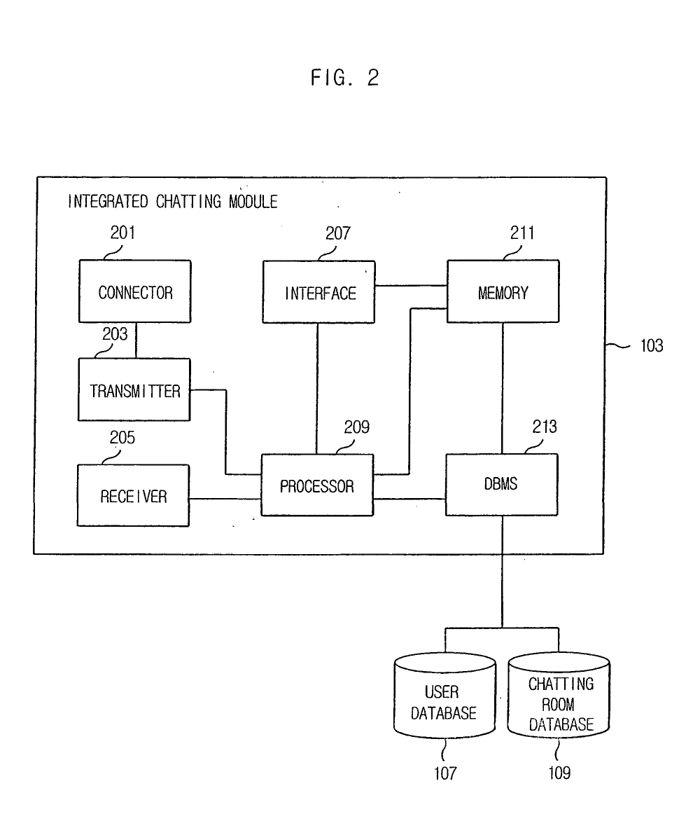

FIG. 2 is a schematic diagram illustrating a chatting module comprised on a server in the present invention.

Referring to FIG. 2, the chatting module 103 makes a chatting room and transmits a user chatting module 117 to a chatting user's computer.

Also, the chatting module 103 receives data from each of the chatting users and transmits it to them.

The chatting module 103 is composed of a connector 201, a transmitter 203, a receiver 205, an interface 207, a processor 209, a memory 211 and a DBMS (database management system) 213.

The connector 201 connects with the user PC 113 of the chatting user.

The transmitter 203 transmits a chatting content of text format or tag format to the user chatting module 117 of the user PC 113. The tag format is a type which can be analyzed by a web browser like an HTML format.

The receiver 205 receives the chatting content of text format or tag format from the user chatting module 117 of the user PC 113.

The interface 207 composes a chatting page by using information provided by memory 211.

The processor 209 compares or judges the information transmitted from the memory 211, the transmitter 203 and the DBMA 213, and accomplishes a process.

The memory 211 stores the program relating to the page and the process provided by the chatting server 101.

The DBMS (database management system) 213 extracts information from the user database 107 or the chatting room database 109.

Also, the DBMS (database management system) 213 stores the data, which was transmitted from the transmitter 203 or the processor 209, on the user database 107 or the chatting room database 109.

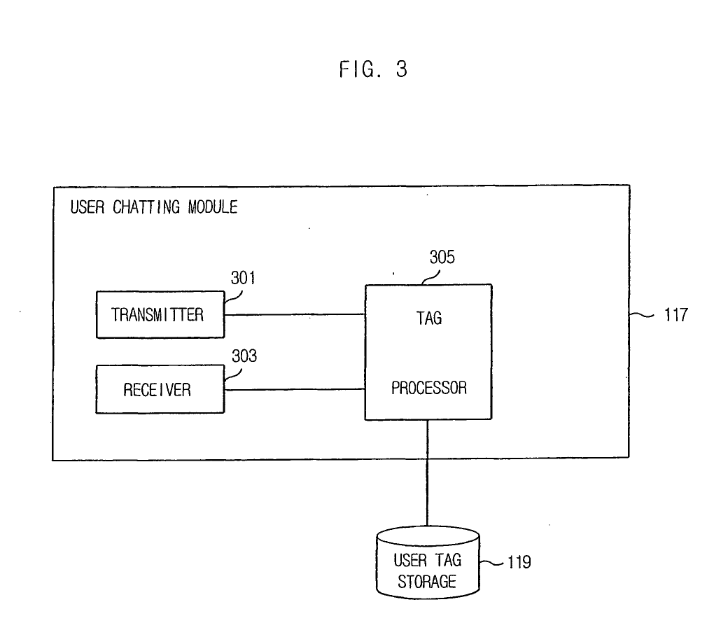

FIG. 3 is a schematic diagram illustrating a user chatting module providing a real-time tag analysis in the present invention.

Referring to FIG. 3, the user chatting module 117 is composed of a transmitter 301, a receiver 303, and a tag processor 205.

The transmitter 301 transmits transmission source data to the chatting module 103 of the chatting server 101. The transmission source is displayed in the chatting window and transmitted to the chatting server 101 in response to the user's transmission order.

The receiver 303 receives the first source data copied by the user.

The tag processor 305 converts the first source data to the second source data, which is a tag format. Also, the tag processor 305 stores the second source data to the user tag storage 119 or the user PC 113. The user tag storage 119 is a buffer and assigned by the user chatting module 117.

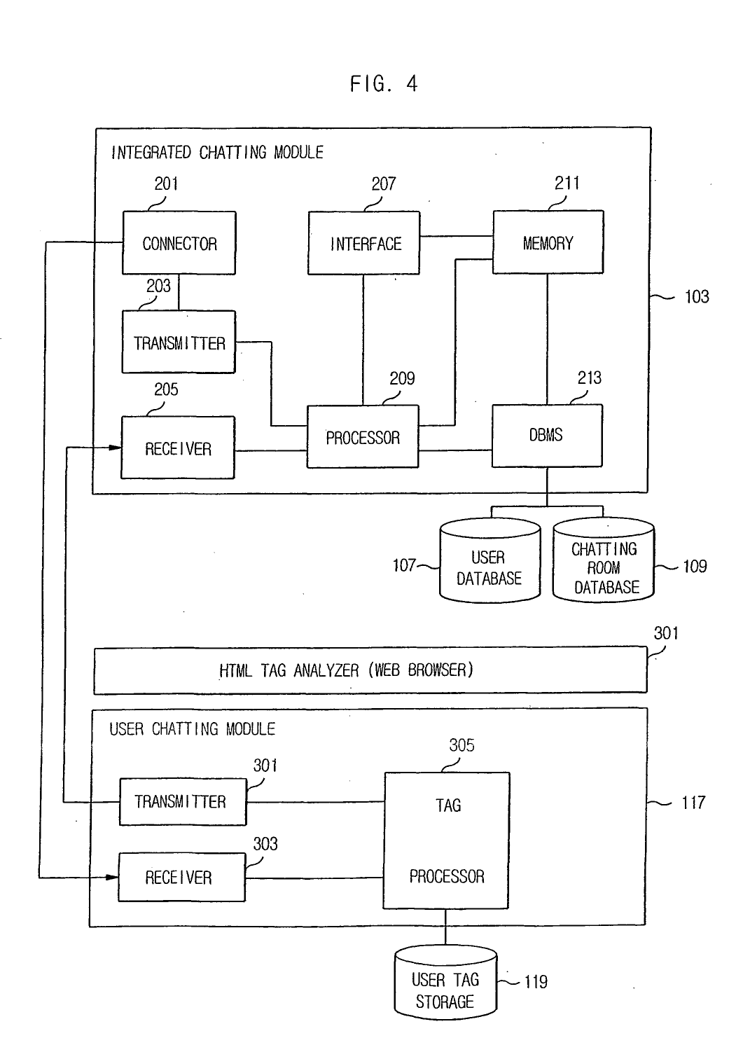

FIG. 4 is a schematic diagram illustrating an operating relationship of the chatting module and the user chatting module in the present invention.

Referring to FIG. 4, each user PC 113 has a user chatting module 117 and the user PC 113 has a tag analyzer (web browser) 115. The tag analyzer (web browser) analyzes the transmission source data, which is transmitted from the chatting server 101, and displays the contents like a text, an image and a moving picture.

If the user copies the first source data displayed in the web browser, then the receiver 303 receives the first source data. The first source data is one among a text, an image, and a moving picture and comprises tags.

If the first source data transmits to the tag processor 305, then the tag processor 305 converts the first source data to the tag-formatted second source data and stores the second source data at the user tag storage 119 and transmits the second source data to the transmitter 301. The step of storing the second source data at the user tag storage 119 will be omitted.

If the transmitter 301 transmits the transmission source data and the user's information to the chatting module 103 of the chatting server 101, then the receiver 205 of the chatting module 103 receives the transmission source data and the user's information and transmits them to the processor 209.

The processor 209 extracts the list of other chatting user by using the user's information and transmits the transmission source data and the chatting user list to the transmitter 203.

The transmitter 203 transmits the transmission source data to each user PC 113 corresponding to the chatting user list.

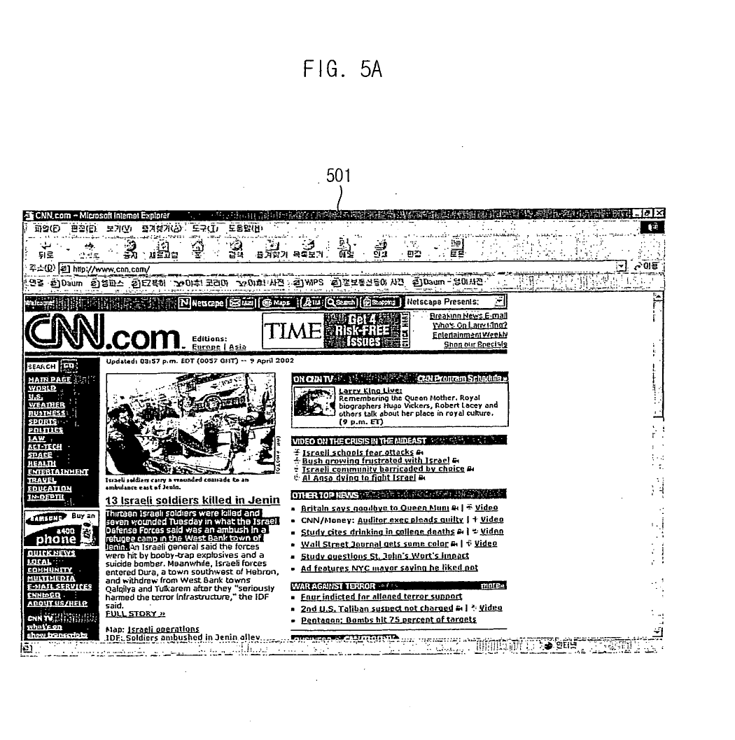

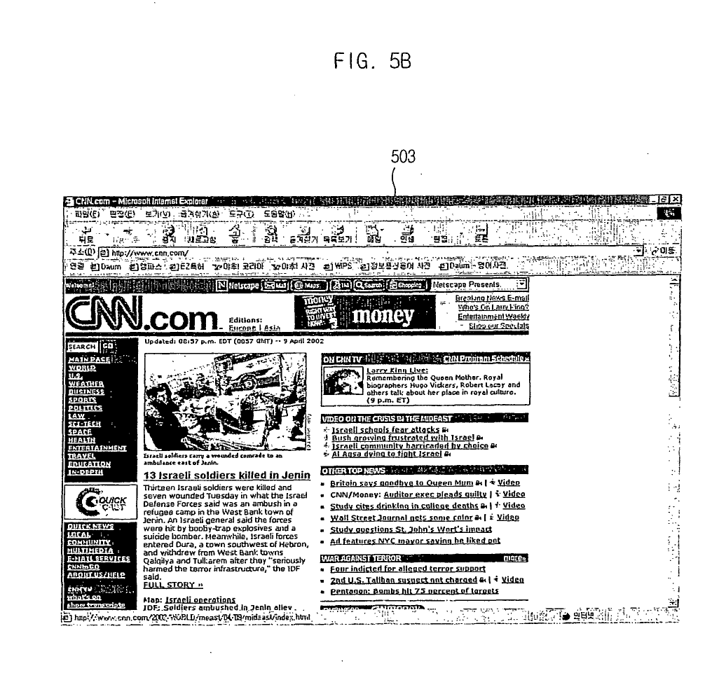

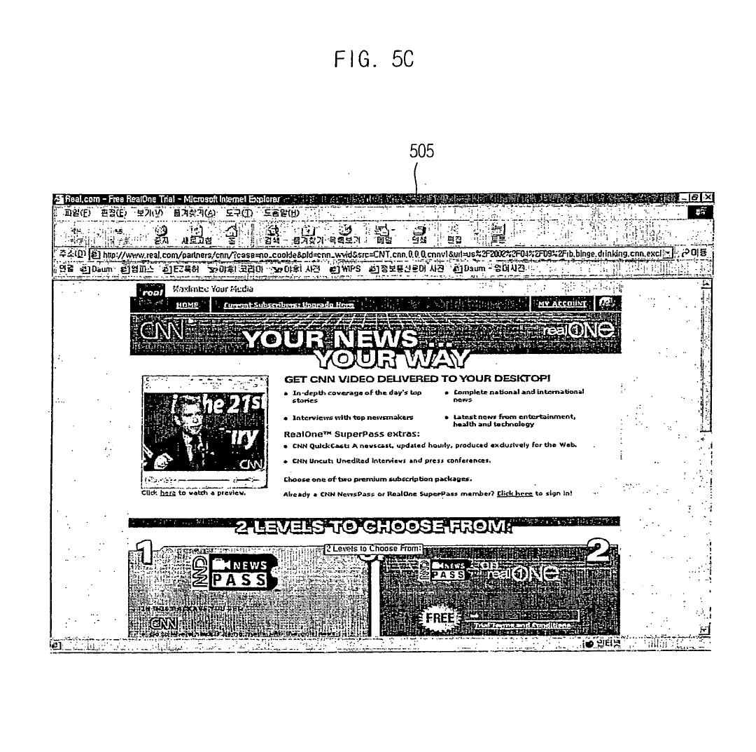

FIG. 5a is a writing page for providing a text copy on a web browser in the present invention.

FIG. 5b is a writing page for providing an image copy on a web browser in the present invention.

FIG. 5c is a writing page for providing a moving picture copy on a web browser in the present invention.

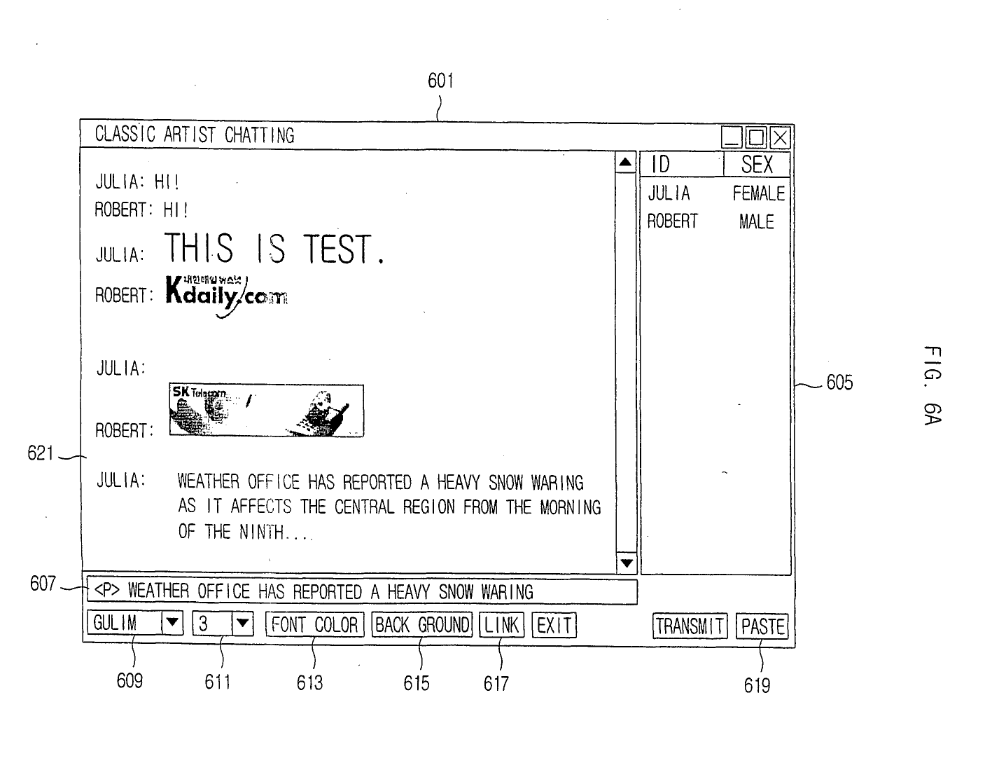

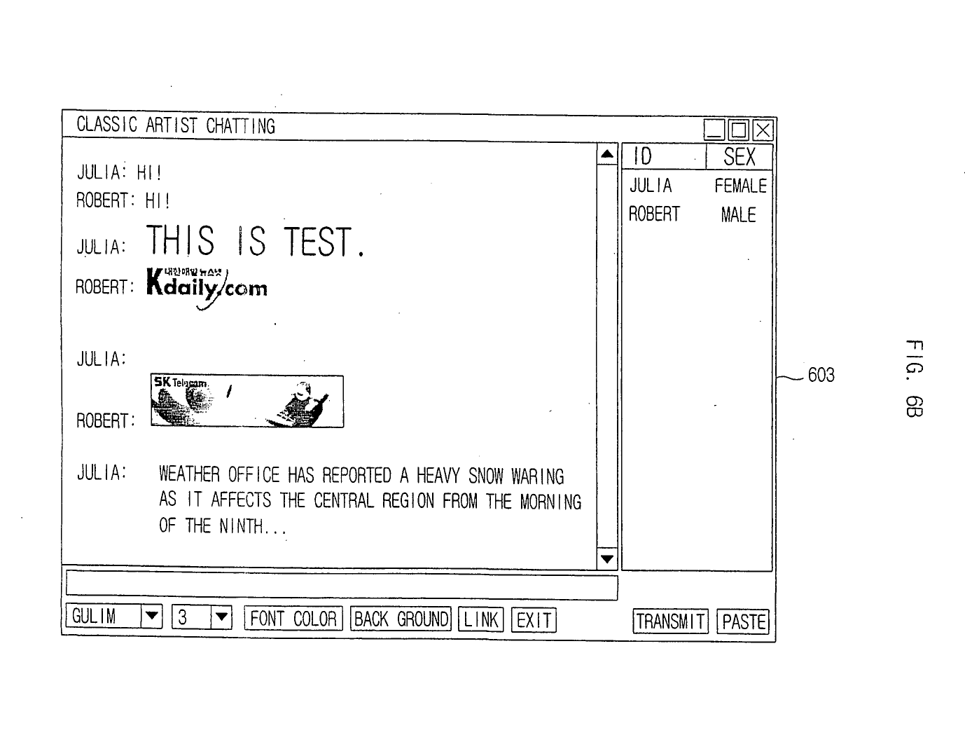

FIG. 6a is a chatting page for transmitting a copied tag (text) in the present invention.

Referring to FIG. 6a, the chatting page 601 is composed of a chatting user display part 605, a chatting display part 621, a chatting input part 607, a font type selection part 609, a font size selection part 611, a font color setting button 613, a background color setting button 615, a link setting button 617, a paste button 619 and so on.

The user inputs a text in the chatting input part 607 and selects a font type of the text in the font type selection part 609.

Also, the user can select the font size of the text in the font size selection part 611 and set up the font color of the text by using-the font color setting button 613 and set up the background color of the text by using the background color setting button 615.

Also, the user can set up the link of the text by using the link setting up button 617.

If the user clicks the paste button 619, then the first source data copied by the user is transmitted to the receiver 303 of the user chatting module 117 and converted to the tag source. The converted tag source is displayed in the chatting input part 607.

The first source data displayed in the chatting input part 607 can be edited in the WYSIWYG (what you see is what you get) method by the font type selection part 609, the font size selection part 611, the font color setting button 613, the background color setting button 615, and the link setting button 617.

FIG. 6b is a chatting page for displaying the copied tag (text) in the present invention.

Referring to FIG. 6b, the transmission source data (text) of the FIG. 6a is displayed in the other chatting user's chatting page.

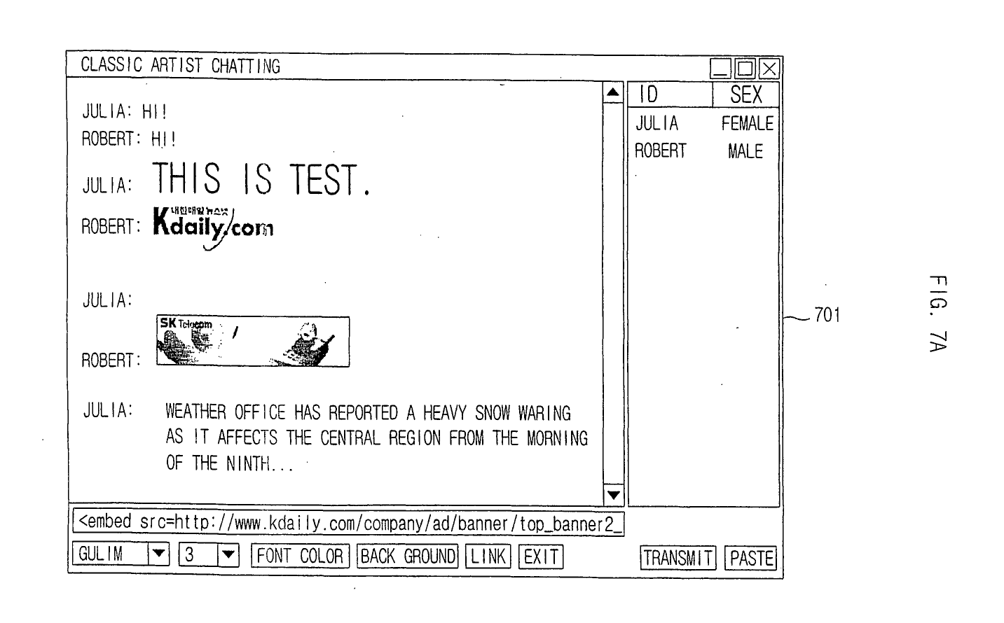

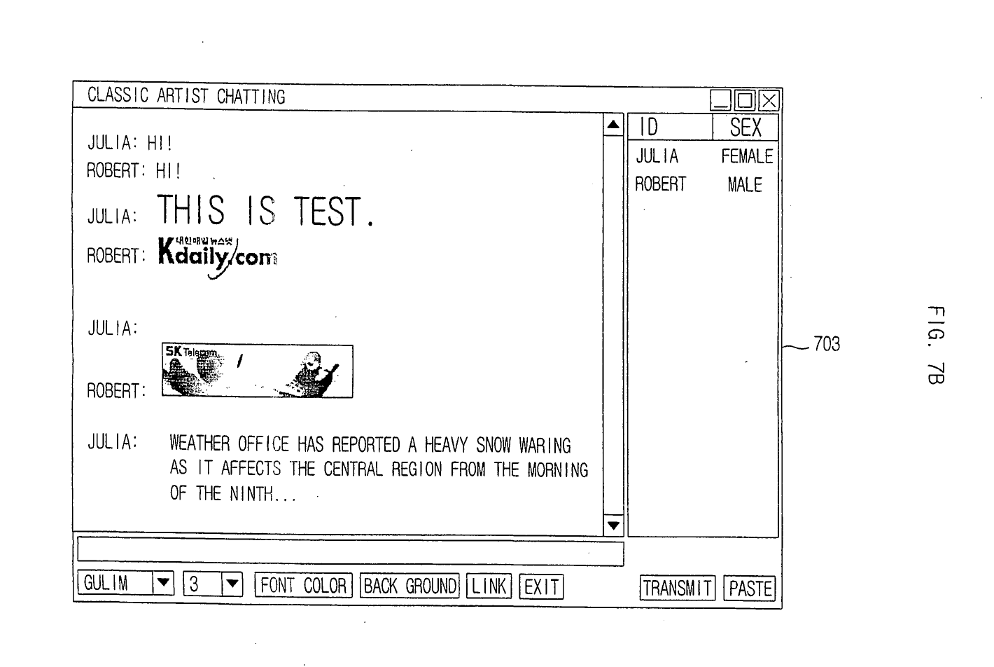

FIG. 7a is a chatting page for transmitting a copied tag (image) in the present invention.

Referring to FIG. 7a, if the user clicks the paste button 619, then the first source data copied by the user is transmitted to the receiver 303 of the user chatting module 117 and converted to the tag-formatted second source data (image). The second source data is displayed in the chatting input part 607.

FIG. 7b is a chatting page for displaying the copied tag (image) in the present invention.

Referring to FIG. 7b, the transmission source data (image) of the FIG. 7a is displayed in the other chatting user's chatting page.

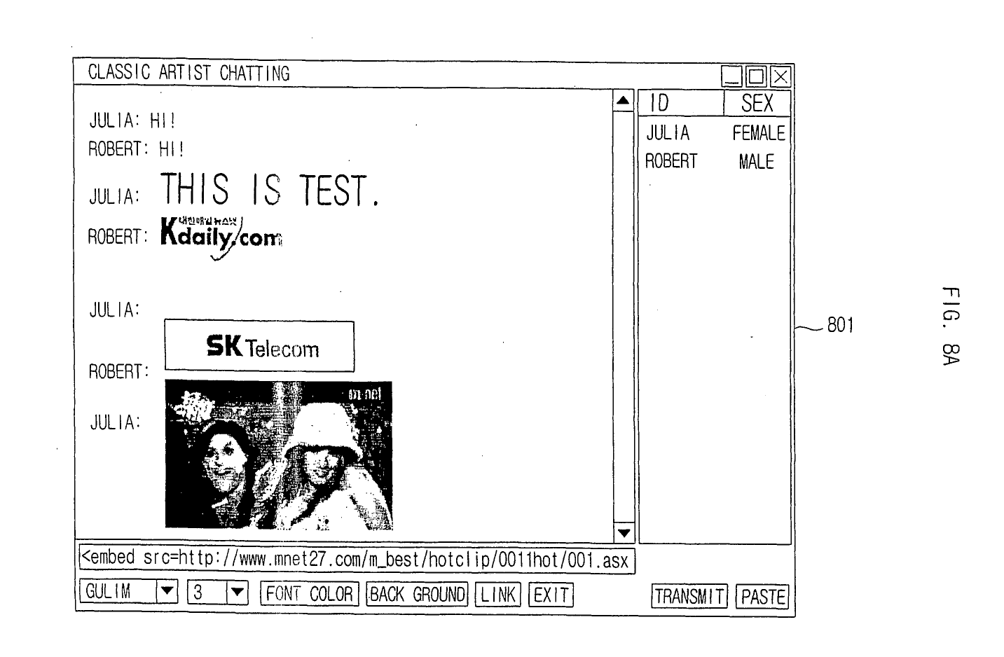

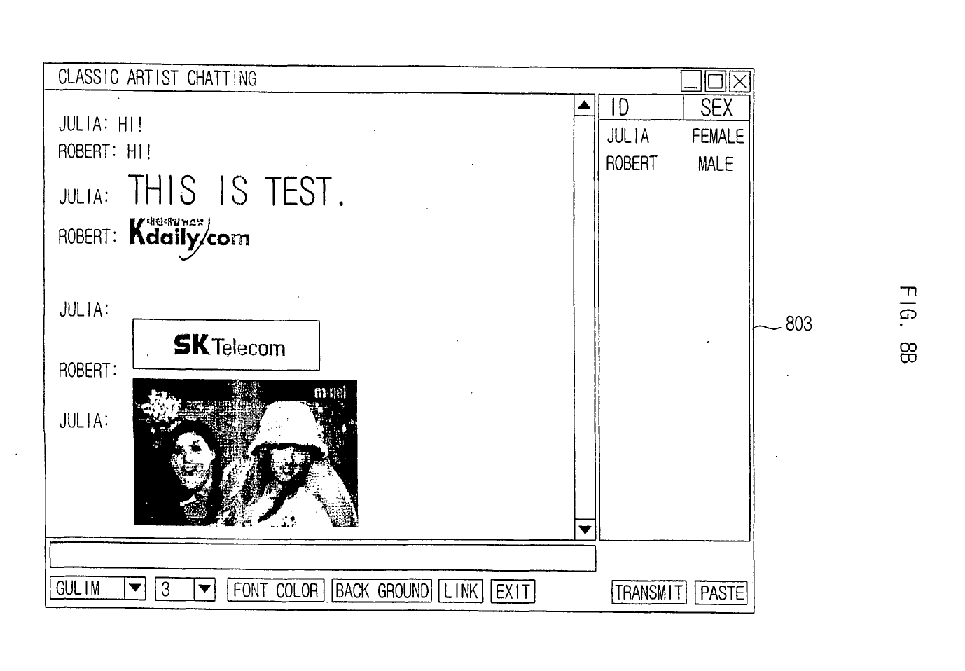

FIG. 8a is a chatting page for transmitting a copied tag, (moving, picture) in the present invention.

Referring to FIG. 8a, if the user clicks the paste button 619, then the first source data copied by the user is transmitted to the receiver 303 of the user chatting module 117 and converted to the tag-formatted second source data (moving picture). The second source data is displayed in the chatting input part 607.

FIG. 8b is a chatting page for displaying the copied tag (moving picture) in the present invention.

Referring to FIG. 8b, the transmission source data (moving picture) of the FIG. 8a is displayed in the other chatting user's chatting page.

The transmission source data like text, image moving picture, and Internet TV can be serviced via coupling with an advertisement.

For example, if the user copies a text, an image, a moving picture and Internet TV in the Chosun daily newspaper site and transmits them to the other chatting users, then the copied contents and the Chosun daily newspaper URL and a banner advertisement, which join with the Chosun daily newspaper site, can be displayed in the chatting display part 621.

Also, if the copied text is copyrighted in the web site, then a copyright alert message can be displayed in the chatting display part 621.

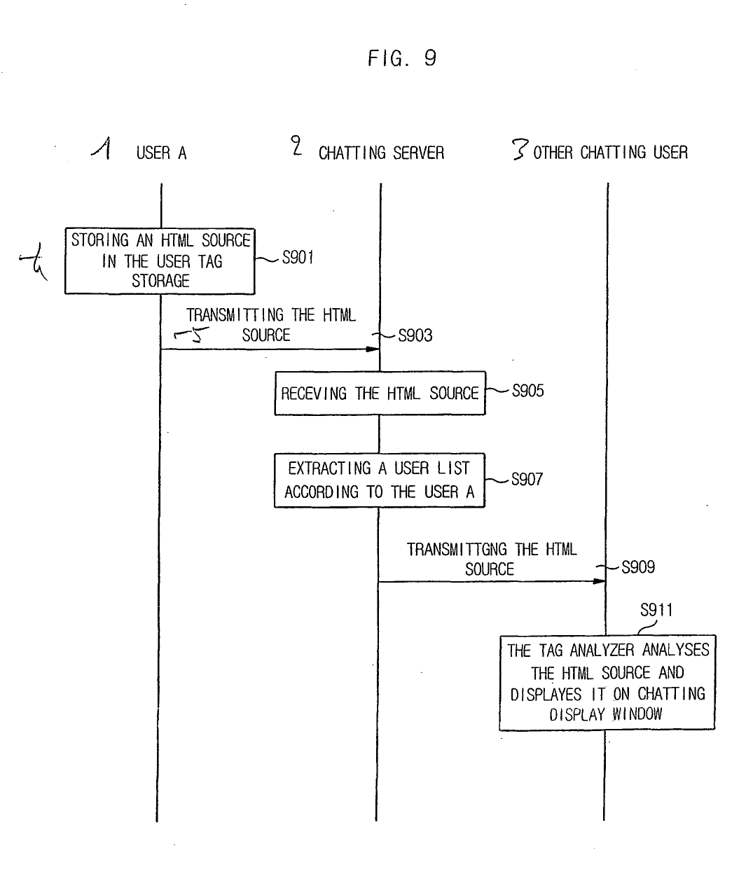

FIG. 9 is a flowchart illustrating the process of analyzing contents into tags on real-time and transmitting the tags in the present invention.

Referring to FIG. 9, if the chatting user (e.g., the chatting user is user A), requests a tag analysis of the copied first source data, then the tag processor 305 receives the first source data and requests an operating system to convert the first source data to tag format. If the tag processor 305 receives the second source data converted to the tag format, then the chatting input part 607 displays the second source data. The second source data can be stored in the user tag storage 119 by the tag processor 305 (S901). If the tag processor receives a transmission request, then the tag processor transmits the second source data (HTML source) as the transmission source data to the chatting server 101 (S903).

If the chatting server 101 receives the transmission source data (S905), then the chatting server 101 extracts other chatting user corresponding to the user A's chatting room (S907) and transmits the transmission source data to the user chatting module 117 of the other chatting user (S909). The other chatting user is a user participating in the chatting room corresponding to user A.

If the user chatting module 117 of the other chatting user receives the transmission source data, then the user chatting module 117 displays the content (text, image and moving picture) corresponding to the transmission source data in the chatting page 601 by using the tag analyzer (web browser and so on) 115 (S911).

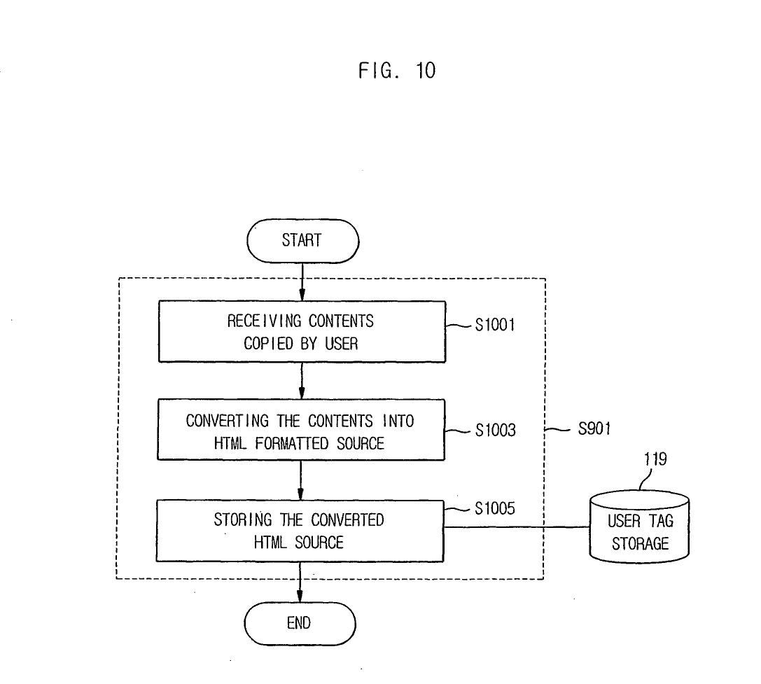

FIG. 10 is a flowchart illustrating the real-time tag analysis process of the user chatting module in the present invention.

Referring to FIG. 10, if the user chatting module 117 of the user PC 113 receives the first source data copied by the user (S1001), then the user chatting module 117 inputs the tag format conversion request of the first source data to the tag format converter of the computer operating system.

The user chatting module 117 converts the first source data to the tag-formatted second source data response to the tag format conversion request (S1003) and stores the second source data on the user tag storage 119 (51005).

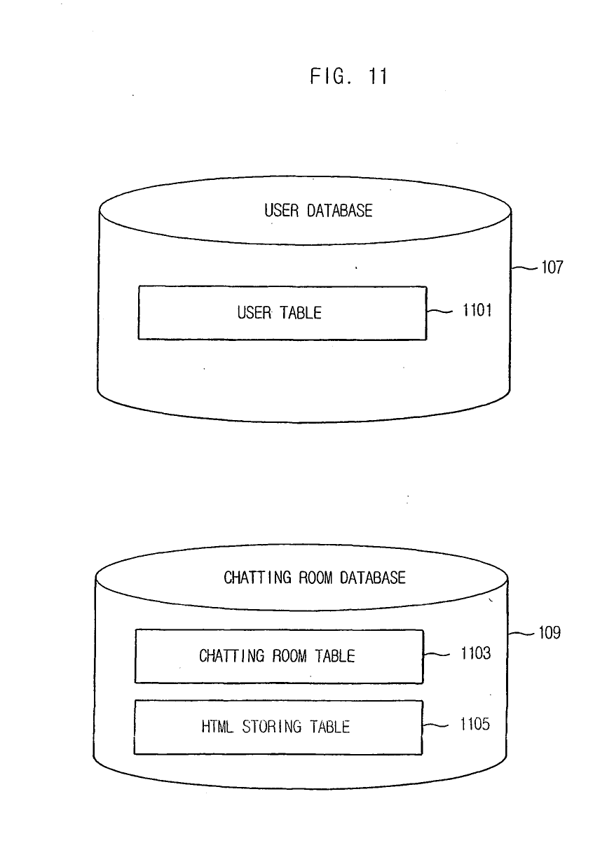

FIG. 11 is a schematic diagram illustrating a user database and a chatting room database in the present invention.

Referring to FIG. 11, the user database 107 comprises a user talk 1101.

The chatting room database 109 comprises a chatting room table 1103 and an HTML storing table 1105.

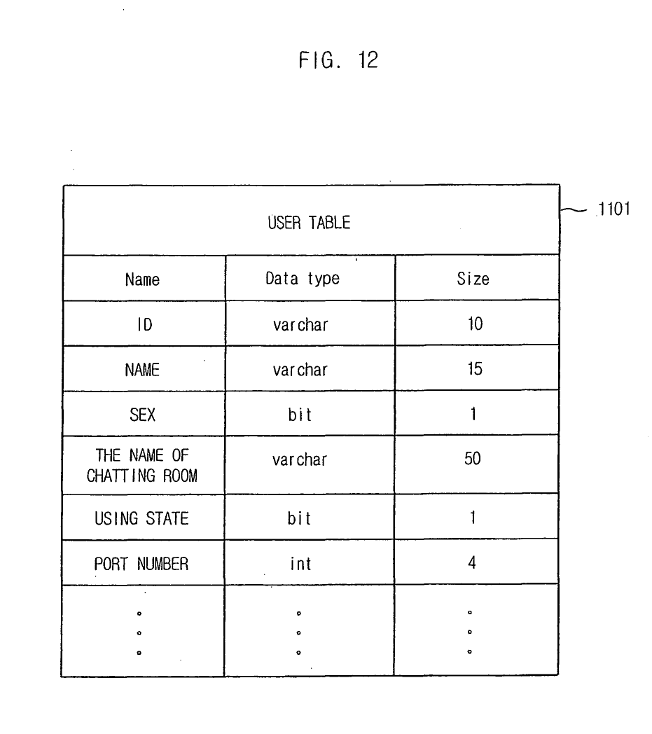

FIG. 12 is a schematic diagram illustrating a user table in the present invention.

Referring to FIG. 12, the user information of the member of the chatting server 101 is stored on the user table 1101. The user table 1101 is composed of columns like user identification, name, sex, the name of chatting room, using state, port number and so on.

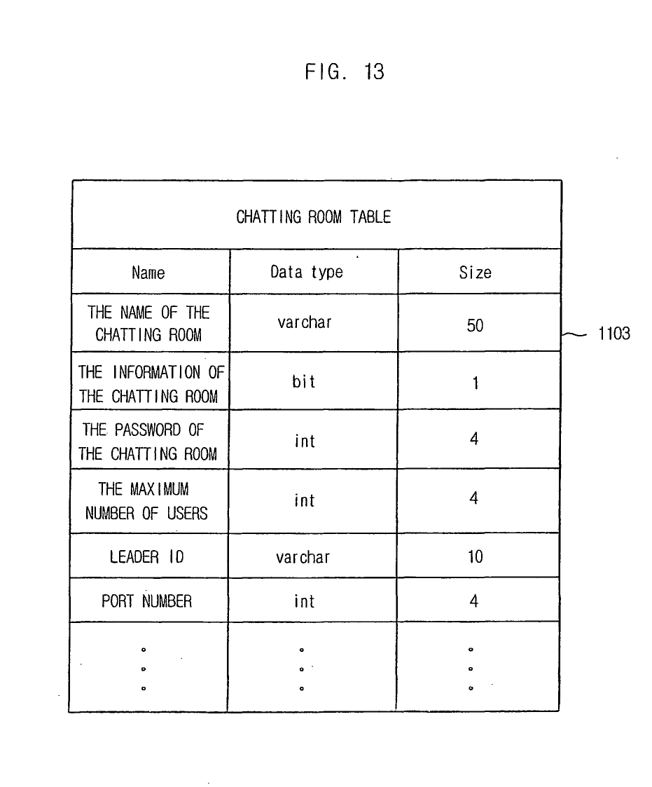

FIG. 13 is a schematic diagram illustrating a chatting room table in the present invention.

Referring to FIG. 13, the chatting room information opened in the chatting server 101 is stored on the chatting room table 1103.

The chatting room table 1103 is composed of columns like the name of the chatting room, the information of the chatting room, the password of the chatting room, the maximum number of users, leader identification, port number and so on.

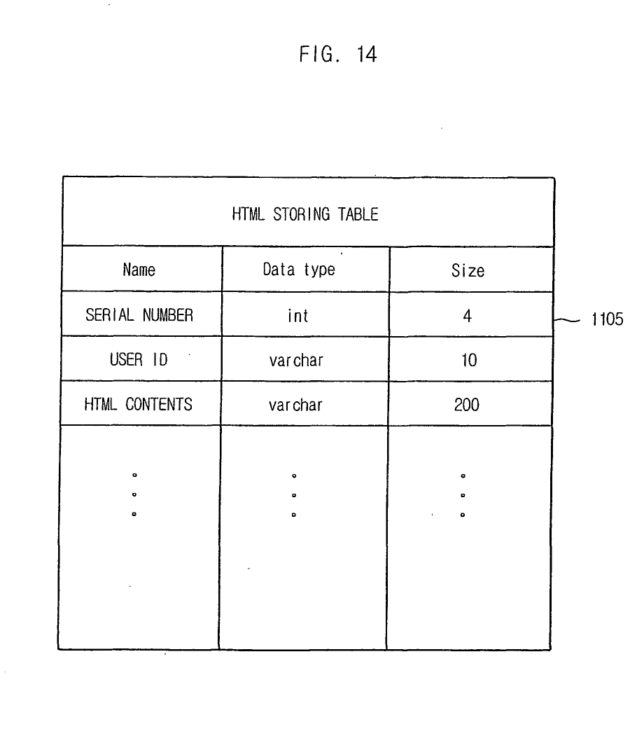

FIG. 14 is a schematic diagram illustrating an HTML storing table in the present invention.

Referring to FIG. 14, the transmission source data transmitted from the user PC 113 is stored on the HTML storing table 1105.

The HTML storing table 1105 is composed of columns like serial number, user identification (“user id”), HTML contents and so on.

The user id is the identification information on the user who registers for the chatting server 101 and uses the chatting service.

The HTML contents are the transmission source data that are transmitted from the chatting server 101 and stored by the real-time tag analysis chatting service.

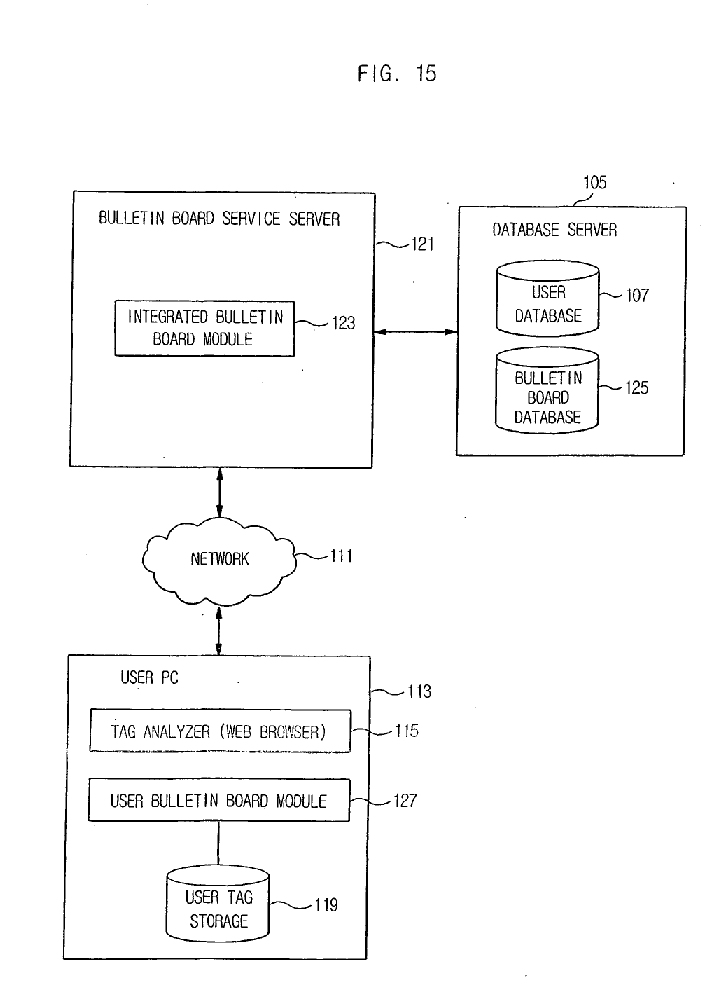

FIG. 15 is a schematic diagram illustrating a bulletin board system in the present invention.

Referring to FIG. 15, a bulletin board service server 121 comprises an integrated bulletin board module 123 and is coupled with the database server 105. The database server 105 comprises the user database 107 and a bulletin board database 125.

The user computer (user PC) 113 has a tag analyzer 115 like a web browser analyzing and displaying tags, and has a user bulletin board module 127 transmitted from the bulletin board service server 121. The user PC 113 comprises the user tag storage 119 which is a buffer.

The user PC 113 is coupled with the bulletin board service server 121 through a network 111.

The user converts the copied content to the tag-formatted data by using the user bulletin board module 127 and transmits it to the bulletin board service server 121.

If the bulletin board service server 121 receives it, then the bulletin board service server 121 registers a writing comprising the tag-formatted data which can be any among a text, an image, and a moving picture.

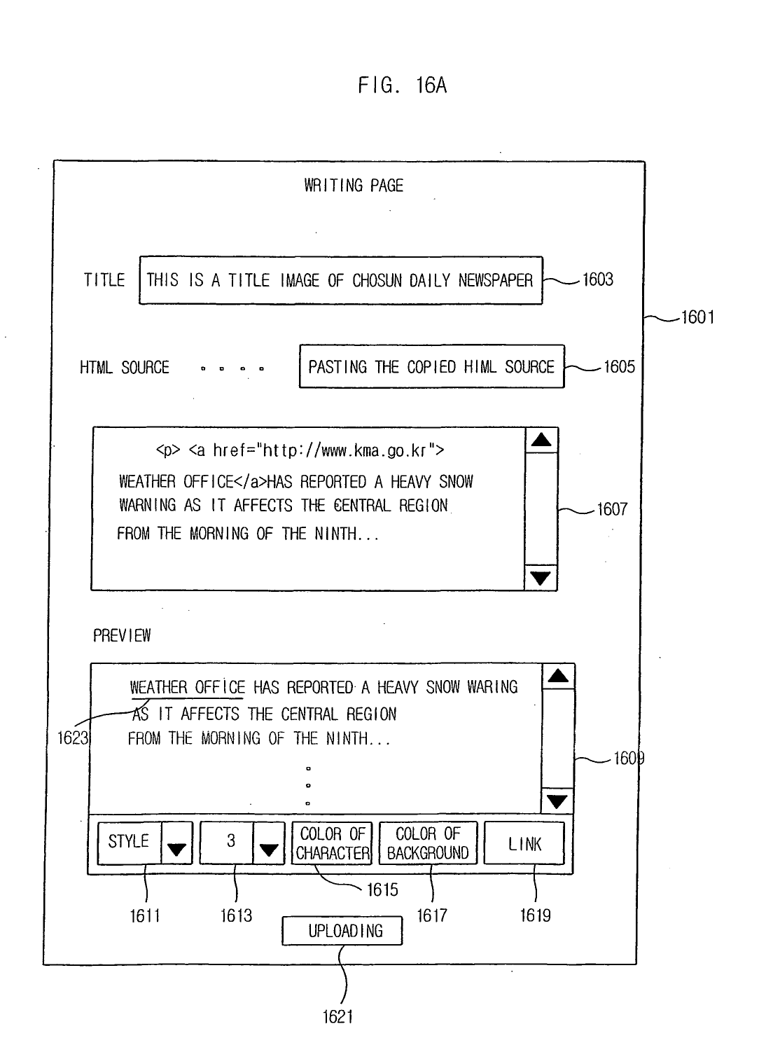

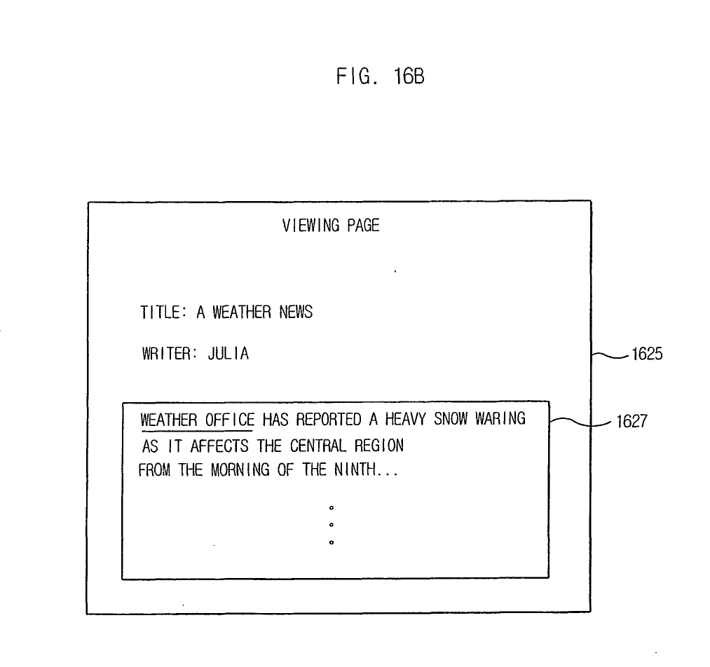

FIG. 16a is a writing page for transmitting a copied tag (text) in the present invention.

Referring to FIG. 16a, the bulletin board writing page 1601 converts the contents copied by the user to the tag-formatted source and provides that the user writes a notice.

The writing page 1601 is composed of a title input part 1603, a bulletin board input part 1607, a paste button 1605, a bulletin board display part 1609, a font type selection part 1611, a font size selection part 1613, a font color setting button 1615, a background color setting button 1617, a link setting button 1619, an upload button 1621 and so on.

The second source data, which are converted into tag-formatted source data by the first source data, are displayed in the bulletin board input part 1607.

If the user clicks the paste button 1605, then the first source data copied by the user are transmitted to the receiver of the user bulletin board module 127 and converted into the tag-formatted second source data and displayed in the bulletin board input part 1607.

The contents, which are inputted in the bulletin board input part 1607, are analyzed by the tag analyzer (web browser) 115 into tags, and the tags are displayed in the bulletin board display part 1609. The user can input texts in the bulletin board display part 1609 and set up the font type, the font size, the font color, and link of the text. The contents, which are inputted in the bulletin board display part 1609, are converted by the user bulletin board module 127 into the second source data and displayed in the bulletin board input part 1607.

The user inputs a text in the bulletin board input part 1607 and selects a font type of the text, which is displayed in the bulletin board display part 1609, in the font type selection part 1611.

Also, the user can select the font size of the text in the font size selection part 1613 and set up the font color of the text by using the font color setting button 1615 and set up the background color of the text by using the background color setting button 1617.

Also, the user can set up the link of the text by using the link setting up button 1619.

If the user clicks the upload button 1621, then the second source data are transmitted to the integrated bulletin board module 123 of the bulletin board service server 121 as the transmission source data.

FIG. 16b is a viewing page for displaying the copied tag (text) in the present invention.

Referring to FIG. 16b, the viewing page 1625 is composed of a title part, a writer part, and a bulletin board display part 1627.

The contents, which are inputted by the user as the transmission source data and analyzed by the tag analyzer (web browser) 115, are displayed in the bulletin board display part 1627.

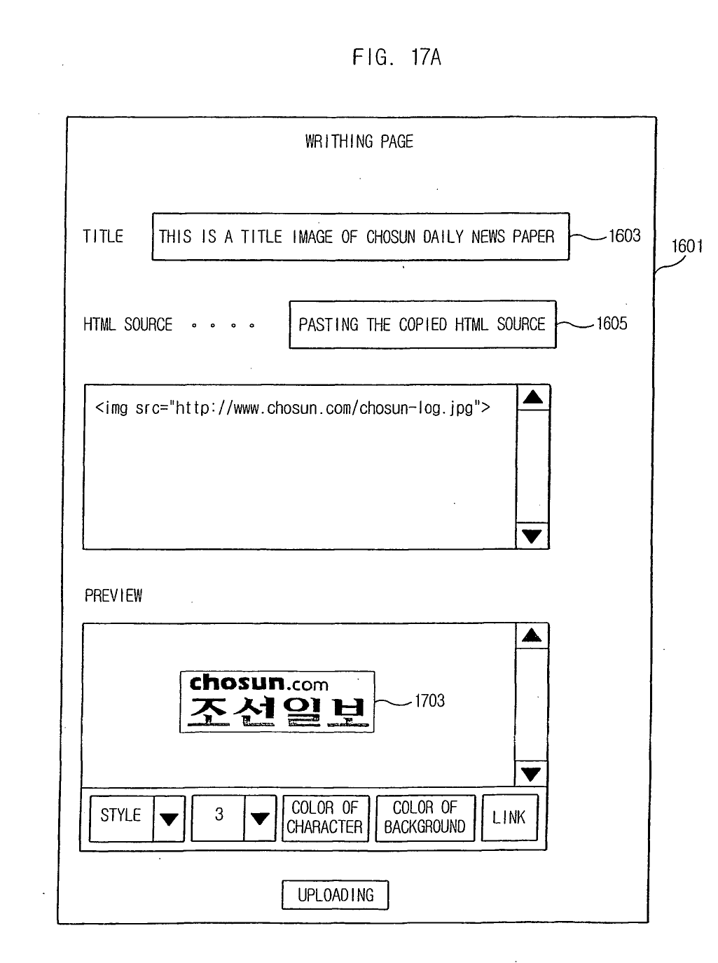

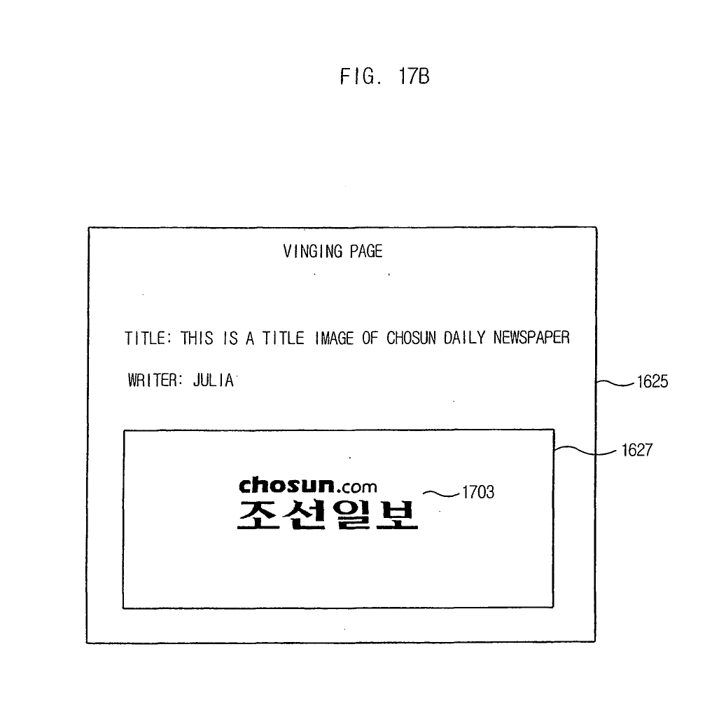

FIG. 17a is a writing page for transmitting a copied tag (image) in the present invention.

Referring to FIG. 17a, if the user copies an image displayed by the web browser and clicks the paste button 1605, then the copied image is transmitted to the user bulletin board module 127. The image is extracted as the tag-formatted second source data from a buffer like a clipboard by the tag process of the user bulletin board module 127.

The second source data is displayed in the bulletin board input part 1607. If the copied image is set up as a link, then the tag processor analyzes the tag 1701 corresponding to the link and displays the analyzed tag in the bulletin board input part 1607. And the image 1703 corresponding to the second source data, which is inputted into the bulletin board input part 1607 and analyzed by the tag analyzer (web browser) 115, is displayed in the bulletin board display part 1609.

FIG. 17b is a viewing page for displaying the copied tag (image) in the present invention.

Referring to FIG. 17b, the image 1703, which is inputted by the user and analyzed by the tag analyzer (web browser) 115, is displayed in the bulletin board display part 1627.

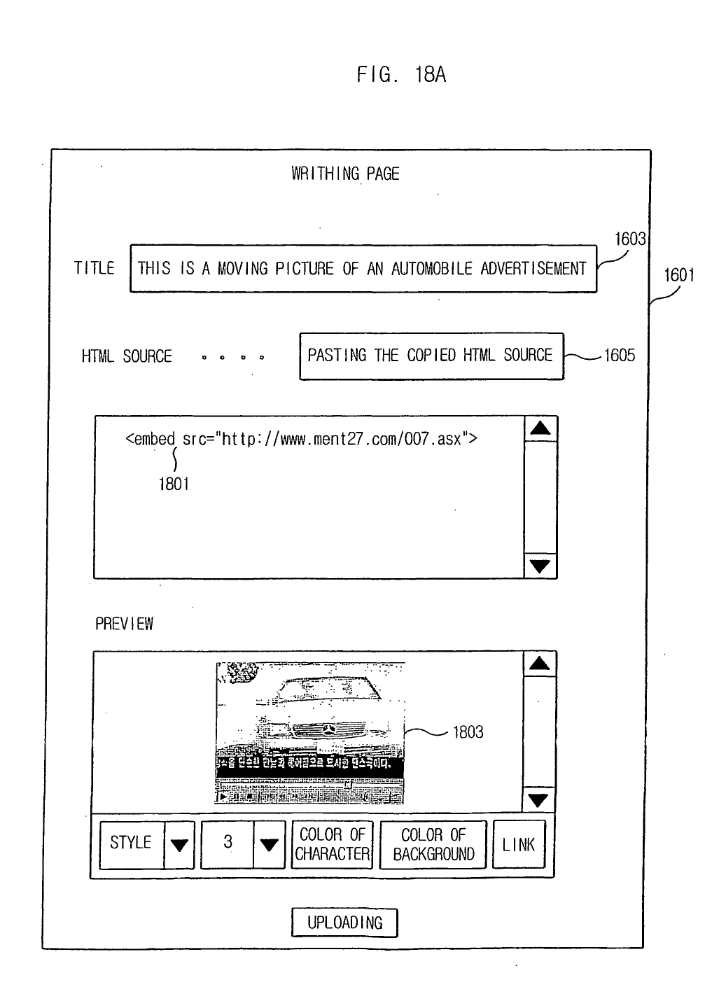

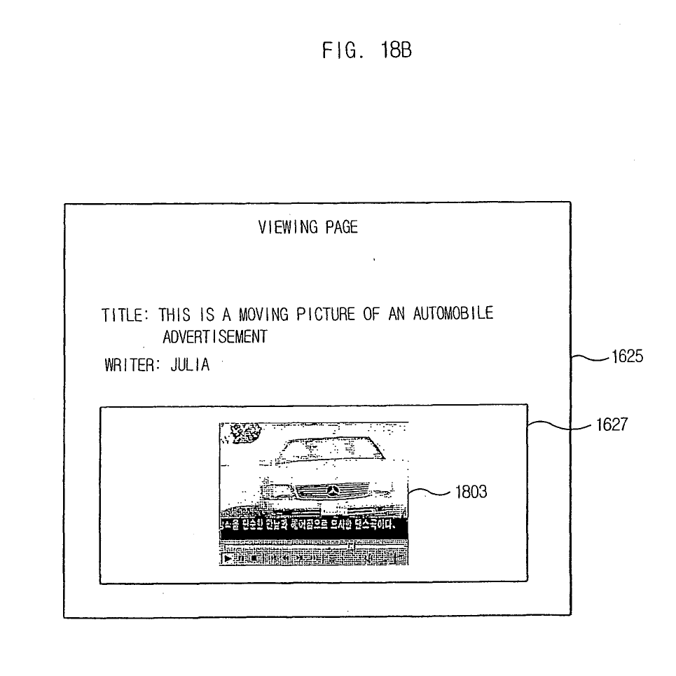

FIG. 18a is a writing page for transmitting a copied tag (moving picture) in the present invention.

Referring to FIG. 18a, if the user copies a moving picture displayed by the web browser and clicks the paste button 1605, then the copied moving picture (the first source data) is transmitted to the user bulletin board module 127. The moving picture is converted into the tag-formatted second source data by the tag processor of the user bulletin board module 127.

The second source data are displayed in the bulletin board input part 1607. And the moving picture 1803 corresponding to the second source data, which is inputted into the bulletin board input part 1607 and analyzed by the tag analyzer (web browser) 115, is displayed in the bulletin board display part 1609.

FIG. 18b is a viewing page for displaying the copied tag (moving picture) in the present invention.

Referring to FIG. 18b, the moving picture 1803, which is inputted by the user and analyzed by the tag analyzer (web browser) 115, is displayed in the bulletin board display part 1627.

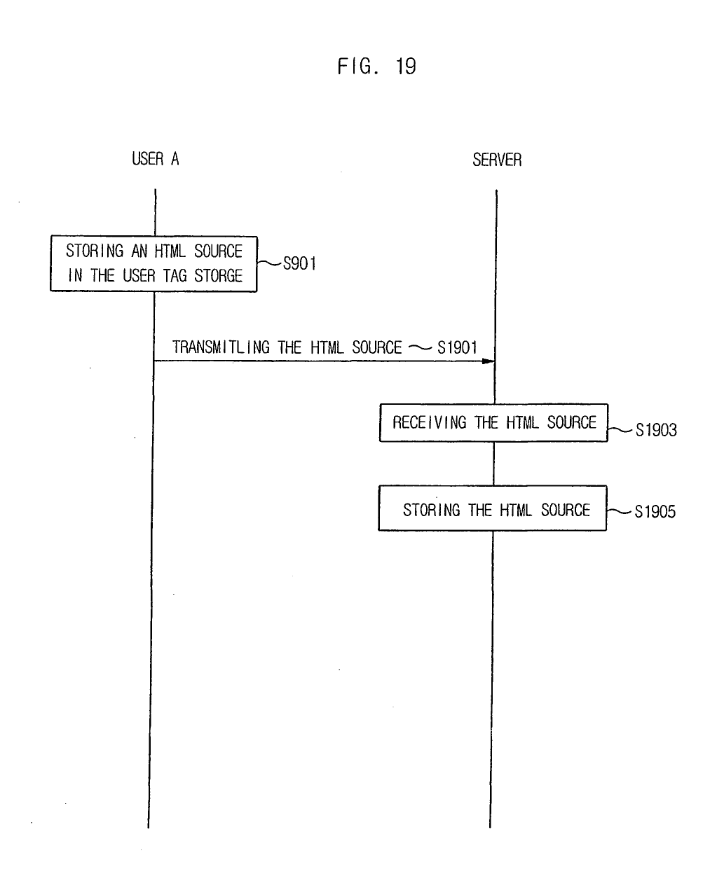

FIG. 19 is a flowchart illustrating an analysis of the contents into tags on real-time and transmitting the tags on the bulletin board system in the present invention.

Referring to FIG. 19, if the user copies the content and pastes the content in the bulletin board input part 1607, the copied content is converted into a tag format source and stored in the user tag storage 119 of the user PC 113 (S901).

If the user clicks the upload button 1621 of the writing page 1601, then the content displayed in the bulletin board input part 1607 is transmitted as the transmission source data to the bulletin board service server 121 (S1901). If the server 121 receives the tag (S1903), then the server 121 stores the transmission source data on the bulletin board database 125 coupled with the server 121 (S1905).

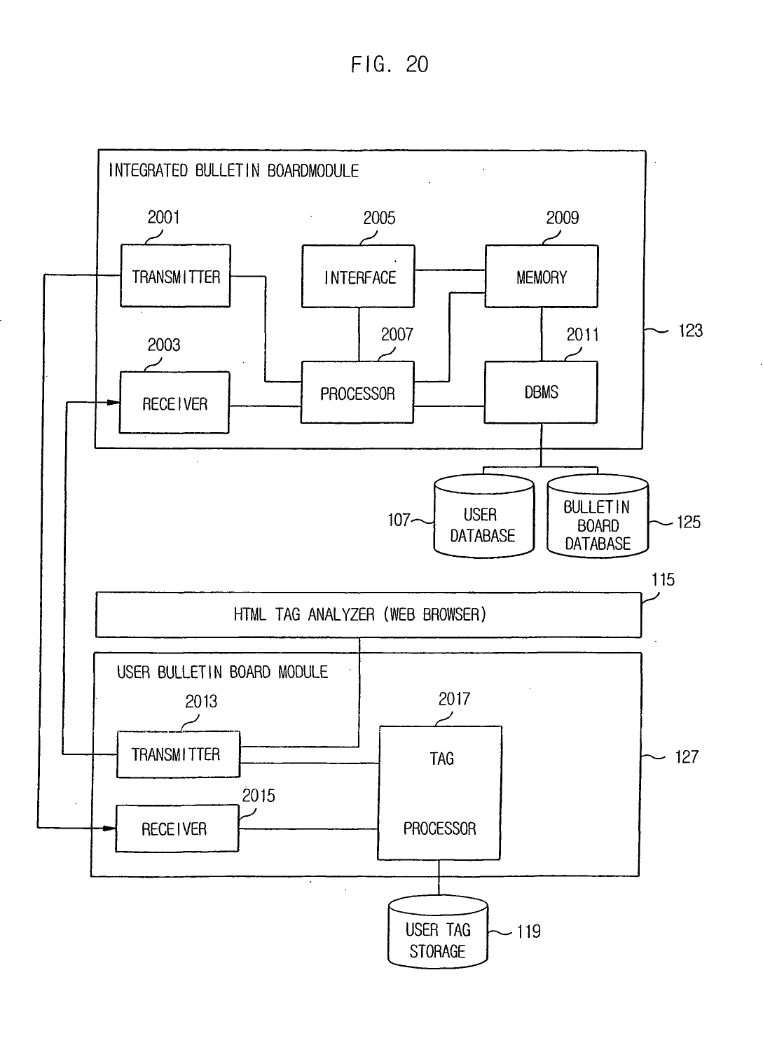

FIG. 20 is a schematic diagram illustrating an operating relationship of the bulletin board module and the user bulletin board module in the present invention.

Referring to FIG. 20, each user PC 113 has a user bulletin board module 127, and the user PC 113 has a tag analyzer (web browser) 115.

If the user copies the first source data displayed in the web browser, then the receiver 2015 of the user bulletin board module 127 receives the first source data. The first source data are any among of a text, an image and a moving picture and comprise tags.

If the first source data are transmitted to the tag processor 2017, then the tag processor 2017 converts the first source data to the tag-formatted second source data and displays the second source data in the bulletin board input part 1607. And the tag processor 2017 stores the second source data at the user tag storage 119 and transmits the second source data to the transmitter 2013. The explanation of the step of storing the second source data to the user tag storage 119 will be omitted.

If the transmitter 2013 transmits the second source data as the transmission source data to the integrated bulletin board module 123 of the bulletin board service server 121, then the receiver 2003 of the bulletin board module 123 receives the transmission source data and transmits it to the DBMS 2011 through the processor 2007.

The DBMS 2011 stores the transmission source data on the bulletin board database 125.

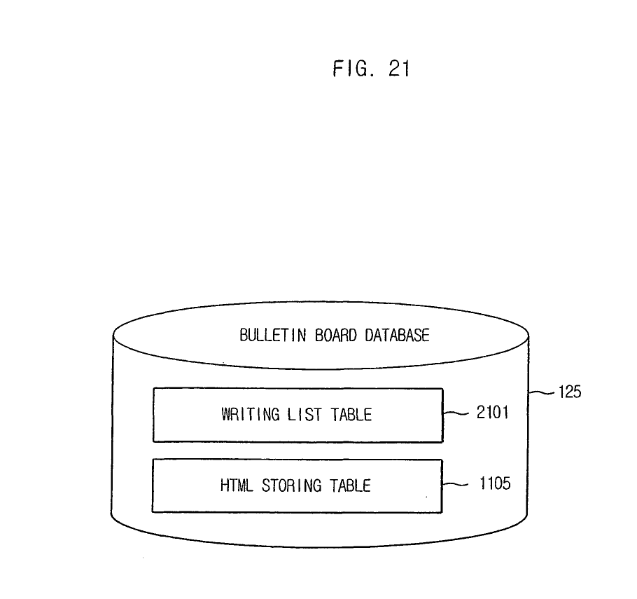

FIG. 21 is a schematic diagram illustrating a bulletin board database in the present invention.

Referring to FIG. 21, the bulletin board database 125 is composed of a writing list table 2101, and the HTML storing table 1105.

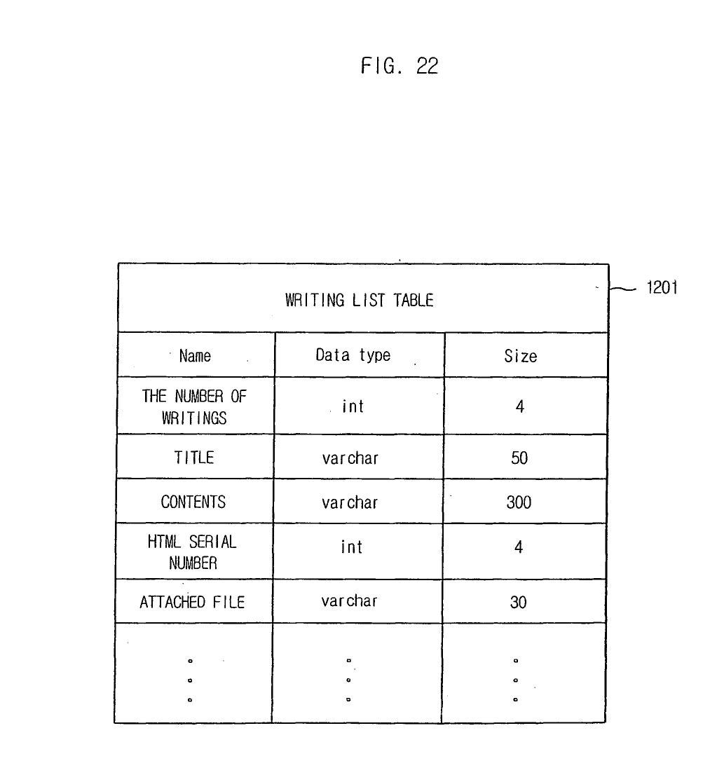

FIG. 22 is a schematic diagram illustrating a writing list table in the present invention.

Referring to FIG. 22, the writing list table 1201 is composed of columns like the number of writings, title, contents, HTML serial number, attached file and so on.

The HTML serial number of the writing list table 1201 is the same number as the serial number of the HTML storing table 1105, and the tag stored in the HTML storing table 1105 is displayed in the bulletin board display part 1627 of the viewing page 1625.

### Industrial Applicability

As described above, according to the present invention, the present invention can provide a chatting method and apparatus for analyzing copied contents into tags on real-time and transmitting analyzed tags to a server.

Also, the present invention can provide a chatting method and apparatus for providing a chatting window that analyzes the copied contents by user into tags on real-time and transmits the tags.

Also, the present invention can provide a chatting method and apparatus for providing a WYSIWYG (what you see is what you get) type tag editing about text, image and moving picture.

Also, the present invention can provide a chatting method and apparatus for analyzing and transmitting a tag corresponding to various types of information like texts, images, moving pictures and Internet TV and link information on real-time.

What is claimed is:

1. A method for providing chatting service with a real-time tag analysis performed on an operating system extracting contents stored in a buffer as tag format based on network, comprising the steps of:
inputting a first source data and a tag format conversion request for the first source data to the operating system, wherein the first source data is stored in the buffer;
receiving a second source data extracted by the operating system, corresponding to the tag format conversion request, wherein the second source data comprises a tag analyzed by a web browser;
displaying the second source data on the user's chatting input window; and
transmitting the second source data as a transmission source data to the other chatting user, wherein the transmission source data is analyzed to a tag and displayed on the other chatting user's chatting display window.

2. The method of claim 1, wherein said operating system has a user chatting module.

3. The method of claim 1, further comprising the steps of:
storing the second source data in a user tag storage.

4. The method of claim 3, wherein the user tag storage is a buffer.

5. An apparatus for providing chatting service with a real-time tag analysis performed on an operating system extracting contents stored in a buffer as tag format based on network, said apparatus comprising:
means for inputting a first source data and a tag format conversion request for the first source data to the operating system, wherein the first source data is stored in the buffer;
means for receiving a second source data extracted by the operating system, corresponding to the tag format conversion request, wherein the second source data comprises a tag analyzed by web browser;
means for displaying the second source data on the user's chatting input window; and
means for transmitting the second source data as a transmission source data to the other chatting user, wherein the transmission source data is analyzed to a tag and displayed on the other chatting user's chatting display window.

6. A computer-readable medium having stored thereon computer-executable instructions and realized in concrete by a program of instructions, which could be executable by a digital processing unit, for providing chatting service method with a real-time tag analysis performed on an operating system extracting the content stored in a buffer as tag format, said chatting service method comprising the steps of:
inputting a first source data and a tag format conversion request for the first source data to the operating system, wherein the first source data is stored in the buffer;
receiving a second source data extracted by the operating system, corresponding to the tag format conversion request, wherein the second source data comprises a tag analyzed by a web browser;
displaying the second source data on the user's chatting input window; and
transmitting the second source data as a transmission source data to the other chatting user, wherein the transmission source data is analyzed to a tag and displayed on the other chatting user's chatting display window.

7. A method for providing chatting service with a real-time tag analysis, comprising the steps of:
inputting a first source data by using a chatting input window; and
transmitting the first source data as a transmission source data to the other chatting user corresponding to the user's transmission request, wherein the transmission source data is analyzed to a tag and displayed on the other chatting users chatting display window.

8. The method of claim 7, further comprising the steps of:
receiving an editing request from the user;
generating a second source data by inserting a tag to the first source data or modifying the first source data according to the editing request; and
displaying the second source data on the chatting input window, wherein the second source data is transmitted to the other chatting user as a transmission source data corresponding to the user's transmission request, and the transmission source data is analyzed simultaneously corresponding to the user's transmission request and displayed on the chatting display window.

9. The method of claim 7, further comprising the steps of:
producing a first display data by analyzing the first source data as tag;
displaying the first display data on the chatting display window;
inputting an editing request for the first display data;
converting the first display data into a second display data according to the editing request;
displaying the second display data on the chatting display window;
converting the first source data into a second source data corresponding to the second display data; and
displaying the second source data on the chatting input window, wherein the second source data is transmitted to the other chatting user corresponding to the user's transmission request as the transmission source data.

10. The method of claim 7, wherein the step of inputting the first source data comprises the steps of:
receiving a copy request from the user;
searching a clipboard data stored in a temporary buffer corresponding to the copy request;
converting the clipboard data into a tag format data; and
displaying the tag format data on the chatting input window.

11. The method of claim 7, wherein the step of inputting the first source data is accomplished by the user's drag and drop request, a source corresponding to at least one object selected by the user's drag and drop is displayed on the chatting input window as the first source data, and the position dragged and dropped is under the chatting display window or the chatting input window.

12. The method of claim 10 or claim 11, wherein the step of inputting the first source data further comprises the steps of:
determining whether or not the first source data comprises an Uniform Resource Locator (URL); and
when the first source data comprises the URL, displaying a copyright warning message.

13. The method of claim 7, further comprising the step of:
storing the second source data in a user tag storage.

14. The method of claim 13, wherein the user tag storage is a buffer.

15. An apparatus for providing chatting service with a real-time tag analysis, the apparatus comprising:
means for inputting a first source data by using a chatting input window; and
means for transmitting the first source data as a transmission source data to the other chatting user corresponding to the user's transmission request, wherein the transmission source data is analyzed to a tag and displayed on the other chatting user's chatting display window.

16. A computer-readable medium having stored thereon computer-executable instructions and realized in concrete by a program of instructions, which could be executable by a digital processing unit, for providing chatting service method with a real-time tag analysis, said chatting service method comprising the steps of:
inputting a first source data by using a chatting input window; and
transmitting the first source data as a transmission source data to the other chatting user corresponding to the user's transmission request, wherein the transmission source data is analyzed to a tag and displayed in the other chatting user's chatting display window.

17. A method for providing bulletin board service with a real-time tag analysis performed on an operating system extracting the content stored in a buffer as tag format based on network, comprising the steps of:
inputting a first source data and a tag, format conversion request for the first source * data to the operating system, wherein the first source data is stored in the buffer;
receiving a second source data extracted by the operating system, corresponding to the tag format conversion request, wherein the second source data comprises a tag analyzed by a web browser;
displaying the second source data on the user's bulletin board input window; and
transmitting the second source data as a transmission source data to a bulletin board server, wherein the transmission source data is stored in a database coupled to the bulletin board server.

18. The method of claim 17, wherein said operating system has a user bulletin board module.

19. The method of claim 17, further comprising the step of:
storing the second source data on a user tag storage.

20. The method of claim 19, the user tag storage is buffer.

21. An apparatus for providing bulletin board service with a real-time tag analysis performed on an operating system extracting the content stored in buffer as tag format based on network, said apparatus comprising:
means for inputting the first source data and a tag format conversion request for the first source data to a operating system, wherein the first source data is stored in a buffer;
means for receiving a second source data extracted by the operating system, corresponding to the tag format conversion request, wherein the second source data comprises a tag analyzed by web browser;
means for displaying the second source data on the user's bulletin board input window; and
means for transmitting the second source data as a transmission source data to a bulletin board server, wherein the transmission source data is stored in a database coupled to the bulletin board server.

22. A computer-readable medium having stored thereon computer-executable instructions and realized in concrete by a program of instructions, which could be executable by a digital processing unit, for providing bulletin board service method with a real-time tag analysis performed on an operating system extracting the content stored in buffer as tag format, said bulletin board service method comprising the steps of:
inputting the first source data and a tag format conversion request for the first source data to a operating system, wherein the first source data is stored in a buffer;
receiving a second source data extracted by the operating system, corresponding to the tag format conversion request, wherein the second source data comprises a tag analyzed by web browser;
displaying the second source data on the user's bulletin board input window; and
transmitting the second source data as a transmission source data to a bulletin board server, wherein the transmission source data is stored in a database coupled to the bulletin board server.

23. A method for providing bulletin board service with a real-time tag analysis, comprising the steps of:
inputting a first source data by using bulletin board input window; and
transmitting the first source data as a transmission source data to a bulletin board server corresponding to the user's transmission request, wherein the transmission source data is stored in a database coupled to the bulletin board server.

24. The method of claim 23, further comprising the steps of:
receiving a editing request from the user;
generating the second source data by inserting a tag to the first source data or modifying the first source data according to the editing request; and
displaying the second source data on the bulletin board input window, wherein the second source data is transmitted to the bulletin board server as a transmission source data corresponding to the user's transmission request.

25. The method of claim 23, further comprising the steps of:
producing the first display data by analyzing the first source data as a tag;
displaying the first display data on the bulletin board display window;
inputting an editing request for the first display data;
converting the first display data into the second display data according to the editing request;
displaying the second display data on the bulletin board display window;
converting the first source data into the second source data corresponding to the second display data; and
displaying the second source data on the bulletin board input window, wherein the second source data is transmitted to the bulletin board server corresponding to the user's transmission request as the transmission source data.

26. The method of claim 23, wherein the step of inputting the first source data comprises the steps of:
receiving a copy request from the user;
searching a clipboard data stored in a temporary buffer response to the copy request;
converting the clipboard data into a tag format data; and
displaying the tag format data on the bulletin board input window.

27. The method of claim 23, wherein the step of inputting the first source data is accomplished by the user's drag and drop order, a source corresponding to at least one object selected by the user's drag and drop is displayed on the bulletin board input window as the first source data, and the position dragged and dropped is under the bulletin board display window or the bulletin board input window.

28. The method of claim 26 or claim 27, wherein the step of inputting the first source data further comprises the steps of:
determining whether or not the first source data comprises an Uniform Resource Locator (URL); and
when the first source data comprises the URL, displaying a copyright warning message.

29. The method of claim 23, further comprising the step of:
storing the second source data in the user tag storage.

30. The method of claim 29, wherein the user tag storage is a buffer.

31. An apparatus for providing bulletin board service with a real-time tag analysis, the apparatus comprising:
means for inputting the first source data by using bulletin board input window; and
means for transmitting the first source data as a transmission source data to a bulletin board server corresponding to the user's transmission request, wherein the transmission source data is stored in a database coupled to the bulletin board server.

32. A computer-readable medium having stored thereon computer-executable instructions and realized in concrete by a program of instructions, which could be executable by a digital processing unit, for providing bulletin board service method with a real-time tag analysis, said bulletin board service method comprising the steps of:
inputting the first source data by using bulletin board input window; and
transmitting the first source data as a transmission source data to a bulletin board server corresponding to the user's transmission request, wherein the transmission source data is stored in a database coupled to the bulletin board server.
